(19) United States
(12) Patent Application Publication
(10) Pub. No.: US 2026/0189913 A1
(43) Pub. Date: Jul. 2, 2026

(54) Method System and apparatus in facilitating anonymous data connectivity

(71) Applicant: Levi Russell, Edgware (GB)

(72) Inventor: Levi Russell, Edgware (GB)

(21) Appl. No.: 19/002,807

(22) Filed: Dec. 27, 2024

(51) Int. Cl. H04W 12/08; H04W 12/03; H04W 12/06; H04W 84/12

(52) U.S. Cl. CPC H04W 12/08; H04W 12/03; H04W 12/068; H04W 84/12

(57) ABSTRACT

The present invention relates to a method, system, and apparatus for enabling anonymous access to Wi-Fi networks within a global community of wireless network hosts and guests. It enhances prior technologies by providing secure and seamless hotspot authentication, eliminating the need for guests to know the host's access credentials. A software application running on both the host and guest devices facilitates the connection, using encryption protocols to ensure security. The invention also introduces a Wi-Fi Bank, where hosts accumulate credits based on their data or time contributions, which guests can redeem for access to other participating hotspots worldwide. This system fosters a sustainable Wi-Fi sharing community, offering affordable internet connectivity and incentivizing hosts to share their networks. By eliminating physical interactions and manual password sharing, the invention makes Wi-Fi sharing more accessible, scalable, and efficient.

### CROSS-REFERENCE TO RELATED APPLICATIONS

This application is related to provisional patent application No. 63/617,096 filed 3 Jan. 2024

### FIELD OF THE INVENTION

The present invention generally relates to the field of wireless communication networks and, more specifically, to systems and methods that enable anonymous Wi-Fi access and secure data connectivity within a global community of wireless network hosts and users. This invention advances existing wireless access point technologies and Wi-Fi sharing platforms by providing a seamless, anonymous, and secure method for users to connect to Wi-Fi networks, alongside a credit-based system that incentivizes network sharing. The invention is especially applicable to the fields of mobile networking, community-based Wi-Fi sharing, and secure authentication technologies. It can be employed in both consumer-level and enterprise-level wireless communication environments

### BACKGROUND OF THE INVENTION

The present invention is an improvement upon U.S. Pat. No. 9,258,309B2, which relates to a method for operating a wireless access point (WAP) to provide network access. As described in a sample embodiment, this patent outlines a system comprising a general-purpose computer or, alternatively, a mobile device connected to the Internet, acting as a hotspot gateway controller to facilitate access for guest devices.

As disclosed in U.S. Pat. No. 9,258,309B2, the device or computer typically operates a single network adapter that communicates wirelessly with both a first sub-network and a second sub-network. The method involves setting up network address and routing table entries for the network interface card (NIC) or module, which controls access from the second sub-network to the network gateway of the first sub-network. This setup facilitates guest access by verifying the user's rights and allowing access if the user is entitled. However, while this system enables network access, it does not address the need for anonymous, secure, and seamless connectivity in a global network of wireless data facilitators and hosts.

With the growing proliferation of fiber-to-the-premises (FTTP) connectivity, commonly known as “full fiber,” Wi-Fi has become the medium of choice for internet access, enabling high-bandwidth applications such as video conferencing, gaming, and remote work. In this evolving landscape, the present invention is essential for creating a worldwide community of users who share their Wi-Fi networks in a reciprocal fashion. This community-based approach requires a secure and anonymous method for users to connect and share access, especially as personal and business networks become increasingly interconnected.

Traditional methods of accessing Wi-Fi networks, such as requiring knowledge of a password or passphrase, can be impractical, especially in scenarios where the guest user does not know or cannot communicate with the network owner. Without a trusted means of communication or identification, guest users may find it difficult, or even impossible, to access the network. The present invention provides a facility that enables users to access Wi-Fi networks anonymously, facilitating the creation of a seamless and secure global Wi-Fi sharing community.

The present invention provides a method for “on-the-fly” secure and anonymous hotspot authentication, facilitated by a software application running on a general-purpose computer or mobile device. For the purposes of this patent application, this system is referred to as the “PC Hotspot”. This improvement allows users to connect to a Wi-Fi network without requiring prior knowledge of the network's password or passphrase.

A significant improvement of the present invention, compared to the method described in U.S. Pat. No. 9,258,309B2, is its ability to facilitate anonymous access to Wi-Fi networks that are secured with common encryption protocols like WEP or WPA. Traditionally, a guest user must know the password or passphrase to access a secured network. The present invention solves this issue by enabling anonymous access without prior interaction between the user and the network host. This system allows users and hosts to join a community and share network access in a seamless and anonymous manner, expanding the possibility for widespread Wi-Fi sharing.

The PC Hotspot provides a secure and anonymous access layer to the community of Wi-Fi users. Unlike traditional systems that require a password to be shared in advance, the PC Hotspot facilitates “on-the-fly” authentication, which eliminates the need for users to communicate directly with the host. The security provided by the system can be based on a password or passphrase, but the key improvement is that this access is facilitated through proprietary software, which can be installed on both the host and guest devices. Additionally, access may also be enabled through local or centralized authentication systems, such as accounting or other means of affinity, offering further flexibility and security.

The present invention improves upon existing Wi-Fi Protected Setup (WPS) methods available in many routers and modems. Traditional WPS requires manual interaction between the host and guest devices, typically by pressing a button on the host device to establish a connection. The present invention eliminates this manual interaction and provides an automated, seamless process for connecting to the hotspot.

The invention also improves on existing software applications that store passwords or access keys in central repositories, such as password keyrings or wallets. The key difference is the “on-the-fly” association between host and guest devices, removing the need for regularly updated password repositories or direct interactions between users.

The invention distinguishes itself from traditional community Wi-Fi services that store user profiles and security access data on centralized servers (e.g., RADIUS or AAA servers). Unlike these services, the present invention does not require centralized authentication or user profile storage. Except where described for credit balances, these services typically require users to create and maintain profiles, making the system less anonymous and less flexible.

The present invention is further distinguished from systems that use QR codes or Near Field Communication (NFC) technologies for sharing passwords. Traditional systems using these methods require the guest user to have prior familiarity with the hotspot host or controller. In contrast, the present invention does not necessitate such familiarity, facilitating a true anonymous and seamless connection.

The present invention introduces an innovative Wi-Fi Bank feature, a system wherein a PC Hotspot host accumulates credit based on the amount of data or time the host provides to the network. This credit, stored and tracked by the software application running on the PC Hotspot, represents the contribution of the host in terms of data usage or time spent sharing connectivity with other users in the global Wi-Fi community. The credit is recorded as either time (e.g., hours of shared connectivity) or data (e.g., the volume of data transmitted), with each host's contribution being logged in the system.

The credit generated by the host is then stored in the Wi-Fi Bank, which functions as a virtual account, accessible via the host's software application. The system tracks the accumulated credits and allows users to monitor their balance. This balance can then be redeemed in the form of data connectivity access to other PC Hotspots around the world. This feature provides an incentive for hosts to share their Wi-Fi networks, creating a sustainable and mutually beneficial model within the community of Wi-Fi facilitators.

When a host wishes to redeem their credit, they can access any participating PC Hotspot within the network. Upon connecting to a new PC Hotspot, the redeemed credit is used to gain access to the Wi-Fi network, enabling users to enjoy secure, anonymous, and seamless connectivity from other hotspot locations, without the need for traditional authentication methods. The redemption process is managed through the Wi-Fi Bank, where credits are debited based on the amount of data or time used for access, providing users with the flexibility to access Wi-Fi resources as needed.

This Wi-Fi Bank and credit system encourages global participation in the sharing economy of Wi-Fi connectivity, creating a decentralized model for users to contribute to and benefit from the collective network of hosts. It also provides an additional layer of incentive for users to participate in the network and contribute their bandwidth, ensuring that the Wi-Fi sharing community remains active, secure, and sustainable.

Ultimately, the present invention seeks to make internet connectivity more affordable and accessible by enabling the creation of a global Wi-Fi sharing community. It leverages readily available technologies and affordable infrastructure, making it easy to install, manage, and scale. By providing secure, anonymous access to Wi-Fi networks, the invention fosters a new paradigm for wireless connectivity, enhancing both personal and business network access on a global scale.

### SUMMARY OF THE INVENTION

The present invention improves upon the concepts described in U.S. Pat. No. 9,258,309B2, which outlines a system where a general-purpose computer or mobile device acts as a hotspot gateway controller to facilitate network access for guest devices.

The present invention provides a method, system, and apparatus for operating a hotspot network that generates a unique SSID and password pair, which is recognized by guest devices seeking access to the network. The method comprises the following key elements:

A first computing device (e.g., PC, laptop, desktop, tablet, smartphone, thin client, server, or similar), operating a single network interface card or module that interfaces with two sub-networks, as described in U.S. Pat. No. 9,258,309B2. This device may also run proprietary software that generates the unique SSID and password pair necessary for access to the network.

A second computing device running the same or similar proprietary software application, which recognizes the generated SSID and password pair required to access the network. The second device may also be any of the computing devices mentioned above.

According to the invention, the system enables seamless, anonymous access to the hotspot network, with both the host and guest devices operating under a secure, shared, and encrypted communication protocol. This connection occurs dynamically and without the need for manual password sharing or physical interaction between the devices.

In a second aspect, the invention includes an apparatus that operates as a hotspot, using a single network interface card or module to generate and exchange data between the two sub-networks, as described in U.S. Pat. No. 9,258,309B2. The apparatus comprises a computing device running proprietary software that generates a unique SSID and password pair, with a second device recognizing and using the generated credentials to access the hotspot.

The system also facilitates a global community of hosts and guests, allowing for reciprocal access to Wi-Fi networks based on a credit system. Hosts generate credits through data or time shared with guest devices, and guests can redeem these credits for access to other PC hotspots worldwide.

In contrast to the prior art, the present invention offers a method for on-the-fly, anonymous hotspot authentication, allowing users to securely access a host network without requiring prior knowledge of passwords or passphrases. The system leverages existing Wi-Fi encryption protocols, such as WEP or WPA, but enhances them by enabling anonymous access through a proprietary software application running on both the host and guest devices.

In addition to enhancing security and privacy, the invention incorporates a Wi-Fi Bank feature, where hosts can earn and store credits based on the time or data they contribute to the network. These credits are tracked by the software and can be redeemed by users to access other PC hotspots worldwide, fostering a global Wi-Fi sharing community. This credit system incentivizes hosts to share their connectivity while ensuring guests can access secure, anonymous Wi-Fi anywhere within the network.

The invention simplifies the process of Wi-Fi sharing by eliminating the need for physical interactions or knowledge of the host's access credentials. It also improves upon existing technologies such as Wi-Fi Protected Setup (WPS), QR codes, and Near Field Communication (NFC) by removing the requirement for direct communication between the host and guest devices. As a result, the system offers a seamless, scalable, and secure solution for worldwide anonymous internet connectivity.

By providing a decentralized and self-sustaining model for Wi-Fi sharing, the invention not only enhances privacy and security but also makes internet connectivity more affordable and accessible for users across the globe. The Wi-Fi Bank system allows users to contribute to and benefit from a worldwide pool of Wi-Fi resources, ensuring the sustainability and growth of the sharing community.

### BRIEF DESCRIPTION OF DRAWINGS

The invention will be further described with reference to the accompanying drawings, which are intended to illustrate embodiments of the present invention. In the drawings:

FIG. 1 illustrates a schematic representation of the PC Hotspot system, showing how a general-purpose computer or mobile device operates as a wireless access point and facilitates access to a network for guest devices.

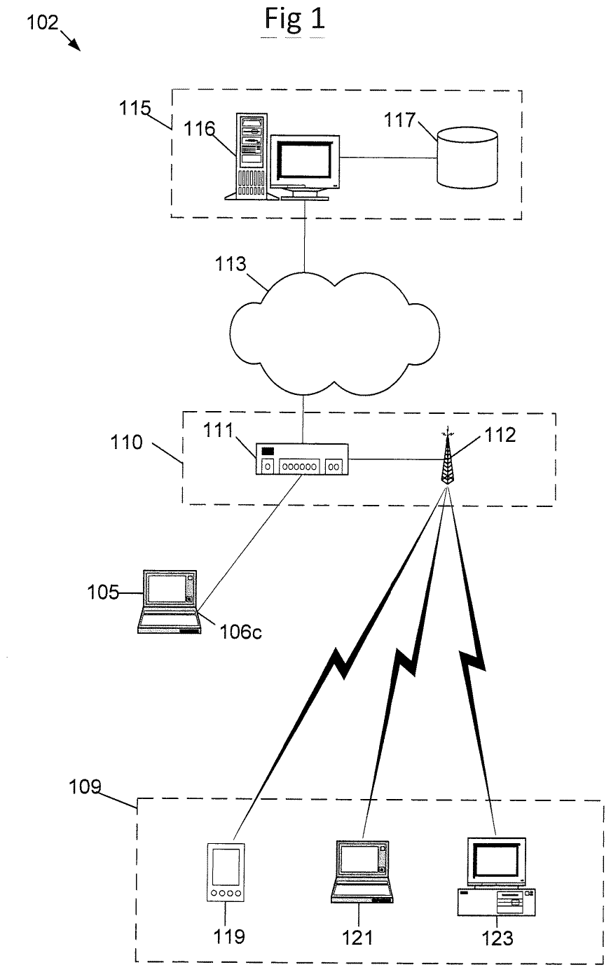

FIG. 2 shows a diagram of the Wi-Fi Bank system, where host devices earn credits based on time or data usage, and how these credits can be redeemed by users to access other participating PC hotspots worldwide.

FIG. 3 illustrates a user accessing the PC Hotspot host network by encountering the unique SSID pass phrase.

FIG. 4 shows a sample map of PC hotspots connected via the Wi-Fi Bank system, illustrating the widespread reach and scalability of the Wi-Fi sharing community facilitated by the present invention.

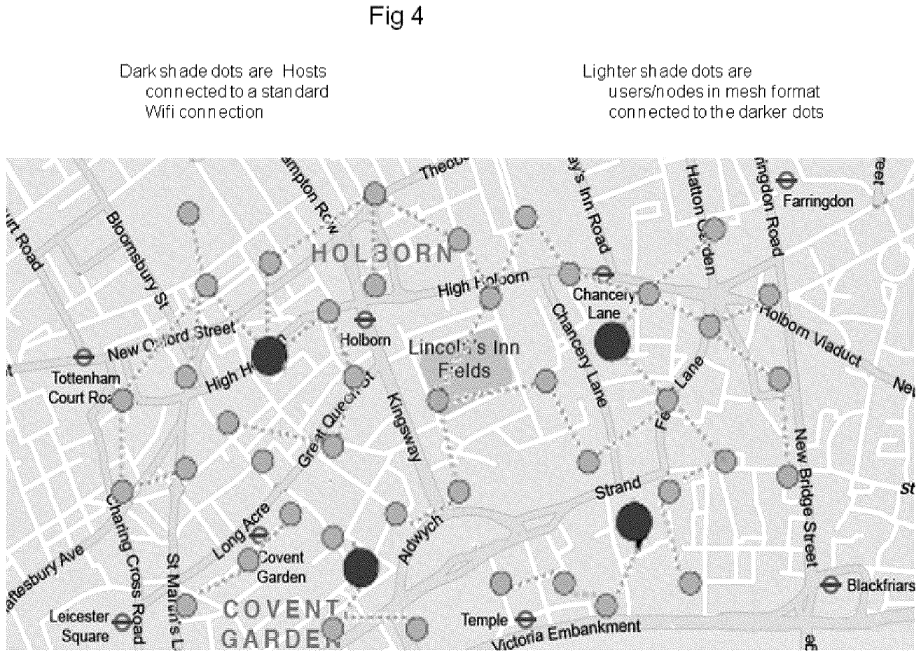

FIG. 5 depicts a flowchart of the on-the-fly anonymous hotspot authentication method, highlighting the process by which guest devices gain access to a secured Wi-Fi network without requiring prior knowledge of the network's password or passphrase

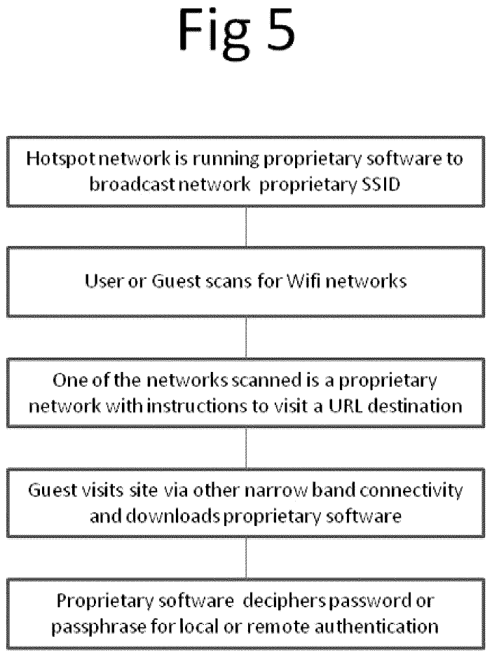

### DETAILED DESCRIPTION OF THE INVENTION

The present invention provides a method, system, and apparatus for enabling anonymous, secure, and seamless access to Wi-Fi networks within a global community of Wi-Fi facilitators and hosts. The invention improves upon existing technologies, such as those disclosed in U.S. Pat. No. 9,258,309B2, by introducing the concept of on-the-fly anonymous hotspot authentication and a Wi-Fi Bank credit system.

The invention is facilitated by the PC Hotspot, which transforms a general-purpose computer or mobile device into a wireless access point. This device, running the proprietary software application, facilitates secure anonymous access to a network for guest devices without requiring prior knowledge of the network's password or passphrase.

The PC Hotspot operates by enabling wireless communication with both a local network (sub-network) and the broader internet. A guest device wishing to access the network can do so without needing direct communication with the host or knowledge of any private access credentials. The authentication process occurs automatically and anonymously, utilizing encryption standards such as WPA or WEP, while eliminating the need for manual password exchange.

The authentication process begins when a guest device attempts to connect to the PC Hotspot. Using the software application running on both the host and guest devices, the system identifies the device and authorizes its access without the guest needing to know the host's password or passphrase. This process is on-the-fly—the device connects and authenticates seamlessly, ensuring anonymous access.

A key aspect of the authentication process is the dynamic establishment of a secure connection between the guest and host. The system employs a combination of encryption and temporary session identifiers to ensure both the security of the connection and the anonymity of the guest. This obviates the need for QR codes, NFC, or physical interaction between host and guest devices.

A unique feature of the present invention is the Wi-Fi Bank, a virtual system where hosts can accumulate credits based on their contributions to the network. These credits are earned based on the amount of data or time the host shares with guests through their PC Hotspot.

Credits are stored and tracked by the software application running on the host device. The Wi-Fi Bank allows hosts to monitor their credit balance, which can then be redeemed for access to other PC hotspots within the global network. This credit system fosters the growth of a mutually beneficial Wi-Fi sharing community, where users are incentivized to contribute their bandwidth in exchange for access to global Wi-Fi resources.

The process of accumulating credits works as follows: A host shares their Wi-Fi network using the PC Hotspot software application. The amount of data or time shared is recorded by the system. This data or time is converted into credits and stored in the host's Wi-Fi Bank account.

When a guest device connects to a different PC Hotspot, the system checks the guest's credit balance. If the guest has sufficient credits, the system grants access to the Wi-Fi network, automatically debiting the appropriate amount of credit. This enables users to access Wi-Fi resources worldwide without requiring direct interaction with the host or knowledge of access credentials.

The redemption of credits occurs automatically when a guest device attempts to connect to another PC Hotspot within the network. The software application verifies the guest's credit balance and ensures that the credit is sufficient to cover the access time or data required for the connection. If the guest has enough credit, the system allows the device to connect to the hotspot, ensuring a seamless and anonymous access experience.

The present invention significantly improves upon the methods described in U.S. Pat. No. 9,258,309B2 and other traditional Wi-Fi access systems by: Eliminating the need for manual password sharing: Guest devices can access the network without the host needing to provide passwords, thus eliminating the need for QR codes, NFC, or WPS systems. Ensuring complete anonymity for guests: Guests do not need to communicate directly with the host, guaranteeing complete anonymity during the authentication process. The credit system enables users to contribute to the global Wi-Fi network and earn access credits, creating a sustainable and scalable sharing economy.

The Wi-Fi Bank system supports a large-scale network of PC Hotspots that can be accessed by anyone within the community, fostering a worldwide Wi-Fi sharing ecosystem.

The software application can be installed on ordinary general-purpose computers or mobile devices. The user interface provides hosts with tools to monitor their credit balance, manage their hotspot settings, and track their contribution to the Wi-Fi community. Guests can view their available credits and seamlessly connect to available hotspots without requiring additional setup or communication with the host.

The system is designed for simplicity, ease of use, and scalability. Hosts can easily set up their PC Hotspot, and guests can connect without the need for special knowledge or training. Additionally, the credit system provides incentives for both hosts and guests to contribute to the community, ensuring that the global network of hotspots remains active and sustainable.

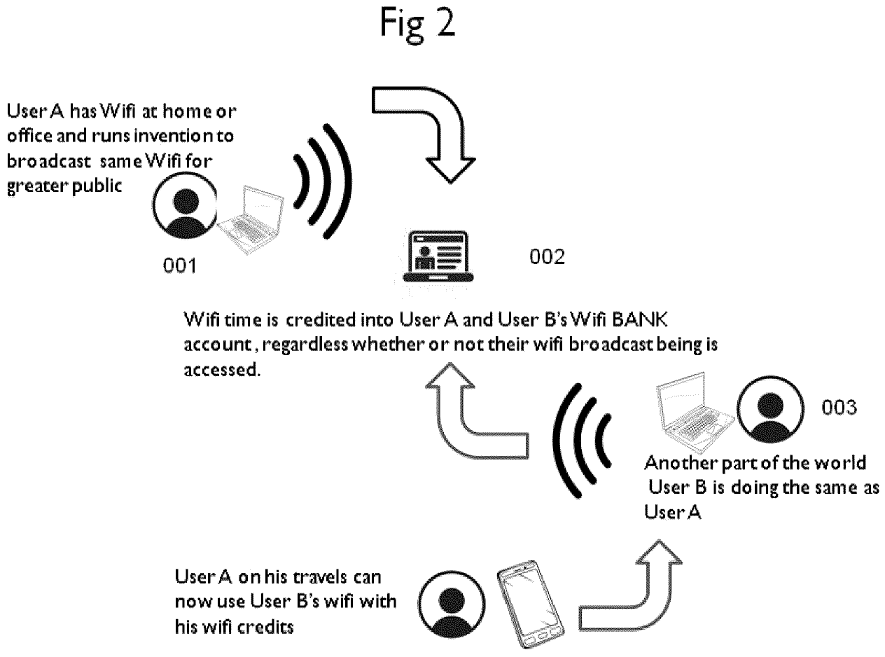

As illustrated in FIG. 2, a User A operates a computing device that runs the proprietary software, effectively converting the device into a PC Hotspot [001]. While the PC Hotspot is active and offering guest Wi-Fi access to the public, User A accumulates credits based on time or data usage in a Wi-Fi credit account [002]. Similarly, User B [003] operates a separate PC Hotspot, and both User A and User B are credited for their contributions. This creates a reciprocal system where both users can redeem credits for access to other hotspots worldwide.

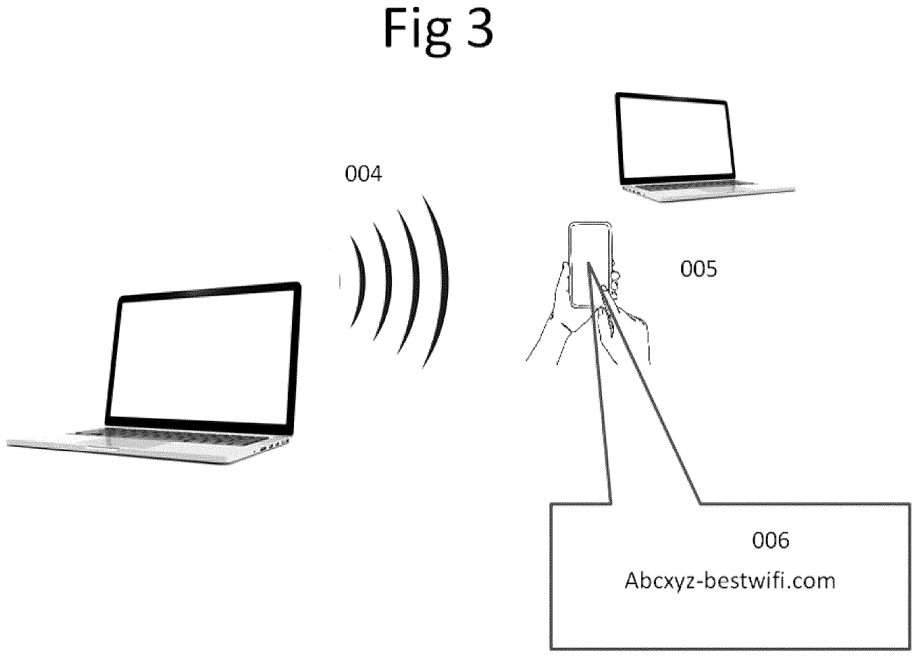

In a preferred embodiment, as illustrated in FIG. 3, User B [004] scans for available Wi-Fi networks while within range of a PC Hotspot [005]. The guest device will display a list of available networks, one of which will have a unique SSID, such as “Abcxyz-bestwifi.com” [006]. The system may direct User B to a URL where the proprietary software application can be downloaded and installed. Once installed, the application enables the guest device to recognize and decode the password or passphrase necessary for accessing the PC Hotspot network.

In another embodiment, the PC Hotspot device broadcasts a secure Wi-Fi network with an SSID comprising a combination of a unique prefix and suffix, which provides additional security. The first computing device generates a proprietary algorithmic password associated with this SSID. The guest device uses the same algorithm to decode the password and gain access to the network.

The system also includes options for local database referencing for user authentication, enhancing the security and reliability of the network.

The PC Hotspot may run on a variety of computing devices, including personal computers, laptops, servers, or mobile devices such as smartphones and tablets.

The system can be implemented in firmware and deployed on routers or modem-like devices, either as a standalone function or alongside standard router/modem functionality.

The SSID and or password may include algorithmically generated characters and symbols (i.e. the SSID prefix and suffix and or password itself) as an added layer of security. The SSID may even be hidden, requiring the guest device to use proprietary software to detect it. The suffix of the SSID may include promotional activities or third-party branding.

The proprietary software application on the guest device may be a standalone application to extract the SSID from a Wi-Fi scan and apply the proprietary algorithm to decipher the security information needed to access the hotspot. The application may interface directly with the device's native operating system.

The guest device may also serve as a host device, providing connectivity to further guests, enabling the creation of a mesh network.

The hotspot network may be a fixed network, such as a home or business network, and both devices may switch roles dynamically, with the software automatically handling these transitions.

While the system is described with specific reference to WEP and WPA security protocols, the invention is not limited to these. It can also be extended to future security methods, such as secure tokens, public key encryption, and other emerging security technologies.

The system can be implemented using a combination of dedicated hardware and software, or fully within software. It is compatible with a wide range of computing devices, including PDAs, mobile phones, and tablets. The methods and apparatuses can be applied to any computing device with network capabilities, and the software may be modular or designed in an alternative configuration to achieve the same functionality.

The invention can also be deployed via a carrier medium carrying machine-readable instructions for controlling a programmable computer or computing apparatus. This could include storage media such as floppy disks, CD-ROMs, DVD-ROMs, or cloud-based servers providing access over networks such as TCP/IP, the Internet, or local area networks.

The present invention speaks of two devices communicating with each other. This does not preclude the possibility of one hotspot network described herein servicing internet and data connectivity to more than one guest device or an unlimited number of guest devices.

Although the invention has been described with specific embodiments, it is understood that variations and modifications may be made to these embodiments without departing from the scope of the invention, as defined by the claims. For example, while the invention describes two devices in the roles of host and guest, these roles can be interchangeable, and the proprietary software can automatically or manually switch between the roles as needed.

Central Server Synchronization embodiment; In some embodiments, the Wi-Fi Bank credit ledger may also be synchronized with a central server or distributed ledger system, enabling account portability and centralized management of credits within the global network of PC Hotspots. The central server may facilitate credit reconciliation, global access, or account synchronization among participants, while maintaining the integrity of the credit transactions verified by cryptographic token exchanges between host and guest devices.

SSID and Password Generation example embodiment; In one embodiment, the proprietary software utilizes a deterministic algorithm to generate the SSID and corresponding password pair. For example, the software may combine a hashed device identifier (such as a MAC address) with a time-based random seed to create a unique SSID suffix and a WPA2-compliant password. The algorithm may use a HMAC-SHA256 function where the MAC address serves as a key and the time seed as input data. This ensures that the SSID/password pair is unique for each device session and resistant to prediction or brute-force attack.

On-the-Fly Authentication Workflow example embodiment; Upon the guest device detecting a participating SSID, the guest device's proprietary software retrieves the SSID prefix and uses a shared algorithm (e.g., AES-based key derivation) to compute the expected password. The software then automatically initiates a WPA2 handshake using the derived credentials without requiring user input. This handshake process adheres to standard 802.11 protocols but leverages the software's key derivation mechanism for dynamic credential exchange.

Wi-Fi Credit Bank Accounting example embodiment; The Wi-Fi Bank system records credit transactions in a local ledger maintained within the software application. Credits may be accumulated based on session duration (e.g., credits per minute connected) or data usage (e.g., credits per megabyte transmitted). The system may utilize a double-entry transaction log to ensure integrity of credit balances. When a guest connects to a host, the software on both devices verifies available credits and exchanges cryptographic tokens that serve as transaction proofs for the ledger system.

Algorithmic Disclosure and Implementation Examples; In the embodiments described herein, the term “algorithm” refers to a sequence of operations performed by one or more processors executing instructions stored in a non-transitory computer-readable medium. The following embodiments provide non-limiting algorithmic examples that enable a person of ordinary skill in the art to implement the SSID/password derivation, on-the-fly association, and or Wi-Fi Bank accounting described in this application.

Participating SSID Format and Versioning; In one embodiment, a participating hotspot network advertises (or otherwise makes discoverable) a service set identifier (SSID) having (i) a prefix identifying participation in the PC Hotspot community and (ii) a suffix that may be algorithmically generated. The prefix may further encode an algorithm version identifier so that different credential-derivation routines can coexist. For example, the prefix may comprise a fixed human-readable string and an algorithm-version field, and the suffix may comprise a truncated, encoded output of a cryptographic function.

Host-Side SSID and Passphrase Derivation (Example); In one embodiment, the first computing device (host) derives an SSID and a corresponding WPA/WPA2/WPA3-compliant passphrase for a session without requiring the host to disclose any pre-existing home or enterprise Wi-Fi password. The host may obtain (a) a device identifier associated with the host (for example a MAC address or another stable identifier), (b) a time-based seed, and (c) one or more secret values stored by the proprietary software. The time-based seed may be derived from a system clock and may optionally be quantized into time intervals to permit short-lived credentials. The host then computes: (i) an SSID suffix value using a cryptographic function (for example HMAC-SHA-256) over at least the device identifier and the time-based seed; and (ii) a passphrase value using a cryptographic function over at least the device identifier, the time-based seed, and optionally the SSID suffix. The resulting SSID and passphrase are formatted to satisfy applicable Wi-Fi requirements (for example passphrase length and character constraints) and are applied by the host to create or configure the hotspot network.

Guest-Side Passphrase Derivation and On-the-Fly Association (Example); In one embodiment, the second computing device (guest) performs a scan for nearby SSIDs and identifies a participating SSID based on the prefix. Using the same or compatible proprietary software, the guest selects the credential-derivation routine indicated by the prefix and derives a candidate passphrase using at least the observed SSID (including the prefix and/or suffix), a device identifier associated with the host (if obtainable from the SSID, beacon/probe response, or other discoverable network information), and a time-based seed. The guest then initiates association/authentication with the hotspot network using the derived passphrase without requiring user entry of the passphrase. To tolerate clock drift, the guest may attempt derivation using a small window of time-based seeds (for example the current interval and adjacent intervals) until association succeeds.

Application-Layer Proof-of-Access Token Exchange (Example); After link-layer association, the proprietary software may perform an application-layer handshake to bind the session to the Wi-Fi Bank accounting system. In one embodiment, the host and guest exchange one or more cryptographic tokens that provide proof-of-access and/or proof-of-consumption for the session. A token may include, by way of example, (a) a pseudonymous host identifier, (b) a pseudonymous guest identifier, (c) a session identifier, (d) a time interval or timestamp, (e) a usage metric (time, bytes, or both), and (f) an integrity value such as a message authentication code (MAC) or digital signature computed over the token fields. In one embodiment, the token is computed using a shared secret known to the proprietary software; in another embodiment, the token is computed using a public/private key pair. The tokens may be exchanged at session start, periodically during the session, and/or at session end.

Tamper-Evident Local Ledger (Example); In one embodiment, the Wi-Fi Bank credit ledger maintained on a device is tamper-evident by storing credit transactions as an append-only sequence where each entry includes (i) the token (or a hash of the token) and (ii) a hash value derived from the previous entry. For example, a ledger entry i may store H_i=Hash (H_{i-1} | token_i), where H_{i-1} is the prior hash value, token_i represents the current transaction proof, and Hash is a cryptographic hash function. This creates a hash-linked chain that allows detection of modification or deletion of entries. Credits may be recorded as positive (earned) entries and debits may be recorded as negative (redeemed) entries, enabling reconciliation of a device balance.

Credit Accrual and Redemption Rules (Example); In one embodiment, credits accrue based on session duration and/or data usage measured by the host and/or guest. The proprietary software may compute a credit delta using a conversion function that maps minutes and/or bytes to a credit unit. Prior to granting continued access or prior to starting a session, the host may verify that the guest has a sufficient balance (locally and/or by reference to prior tokens and ledger entries), and the guest may authorize a debit by presenting a token or by participating in the token exchange described above. These rules may be implemented without requiring the storage of personal identity information, and the system may operate using pseudonymous identifiers.

Central Server Synchronization (Example); In embodiments where a central server is used for portability, the proprietary software may periodically synchronize ledger state with the server. In one embodiment, the device transmits (a) one or more unsynchronized token records (or hashes thereof) and (b) a ledger integrity value (for example the most recent hash value H_n) to the server. The server may validate received records for integrity and update a server-side balance corresponding to the device or account. Synchronization may be periodic, continuous, and/or event-triggered, and may occur opportunistically when the device has connectivity.

Security, Privacy, and Variations; The foregoing algorithmic embodiments are illustrative and non-limiting. Equivalent cryptographic functions, encodings, and key-derivation routines may be used. Secret values used by the proprietary software need not be disclosed to users and may be protected using available operating system security facilities. Identifiers may be salted or hashed to preserve anonymity. The system may be implemented in software, drivers, firmware, or a combination thereof, and may be integrated with operating system hotspot interfaces and Wi-Fi stack APIs. Nothing in these embodiments is intended to limit the scope of the claims, which define the invention.

1. A method of operating a hotspot network, the method comprising the steps of:
Generating a unique SSID and password pair on a first computing device operating a single network interface card or module with two sub-networks, wherein said first computing device is running proprietary software to manage the exchange of data between the two sub-networks;
Providing access to a second computing device by recognizing the unique SSID and password pair generated by the first computing device, wherein the second computing device is running the same or similar proprietary software; Allowing the second computing device to access the network associated with the first computing device using the generated SSID and password pair.

2. The method of claim 1, wherein the first computing device is selected from the group consisting of: a personal computer, laptop, tablet, smartphone, thin client, server, or a similar computing device.

3. The method of claim 1, wherein the unique SSID comprises a prefix followed by a suffix, the prefix being generated algorithmically, and the suffix being used for either security purposes or promotional activities.

4. The method of claim 1, wherein the SSID is hidden, and access to the SSID is provided by the second computing device via proprietary software.

5. The method of claim 1, wherein the second computing device utilizes the proprietary software to decrypt the password or passphrase necessary for connecting to the first computing device's network.

6. The method of claim 1, wherein the access to the network is achieved through the execution of the proprietary software on the second computing device, which interfaces directly with the native operating system of the second device to apply the decryption algorithm.

7. The method of claim 1, further comprising the step of accumulating credit for time or data usage on the first computing device while it is functioning as a hotspot, wherein the accumulated credit can be redeemed by the user of the first computing device for access to other hotspot networks globally.

8. The method of claim 7, wherein credit is stored in a Wi-Fi credit account associated with the first computing device, and the credit is redeemable by accessing other hotspot networks that are part of a global hotspot community.

9. The method of claim 7, wherein the Wi-Fi Bank credit ledger is synchronized with a central server to enable account portability and centralized management of credits within a global network of PC Hotspots.

10. The method of claim 1, wherein the unique SSID and password pair are generated using a time-based seed combined with a device identifier hashed using a cryptographic algorithm.

11. The method of claim 1, wherein the guest device derives the password using a predefined cryptographic algorithm based on the SSID prefix detected in a wireless network scan.

12. The method of claim 7, wherein the accumulated credit transactions are recorded in a secure, tamper-evident ledger maintained on the first computing device.

13. The method of claim 1, wherein the first and second computing devices are capable of exchanging roles as host and guest devices, wherein proprietary software automatically facilitates the switching of roles between the devices.

14. A computing apparatus for acting as a hotspot, the apparatus comprising:
A computing device selected from the group consisting of: a personal computer, laptop, tablet, smartphone, thin client, server, or similar; A single network interface card or module configured to operate two sub-networks; Proprietary software running on the computing device, which generates a unique SSID and password pair; A second computing device running the same or similar proprietary software that recognizes the SSID and password pair generated by the first computing device and grants access to the hotspot network.

15. The computing apparatus of claim 14, wherein the network interface card or module exchanges data between two sub-networks, and the proprietary software facilitates secure access to the second network via the generated SSID and password pair.

16. The computing apparatus of claim 14, wherein the SSID comprises a prefix and a suffix, where the prefix is algorithmically generated for security purposes and the suffix may include promotional or third-party branding.

17. The computing apparatus of claim 14, wherein the SSID is hidden and can only be recognized by the proprietary software installed on the guest device.

18. The computing apparatus of claim 14, wherein the proprietary software includes a cryptographic key exchange module configured to authenticate guest devices prior to network access.

19. A hotspot system, the system comprising:
A first computing device operating a single network interface card or module with two sub-networks that exchange data between them, wherein the first computing device is running proprietary software that generates a unique SSID and password pair; A second computing device running proprietary software that recognizes the SSID and password pair generated by the first computing device and facilitates access to the network of the first computing device.

20. The hotspot system of claim 19, wherein the system allows both the first and second computing devices to switch roles dynamically between host and guest devices, facilitated by proprietary software.

21. The hotspot system of claim 19, wherein the system provides for Wi-Fi credit accumulation, where both the first and second computing devices accumulate time or data credit for their usage, and credits are redeemable for access to other hotspot networks worldwide.

22. The hotspot system of claim 19, wherein the guest device may operate as a mesh network node, providing access to additional guest devices and expanding the hotspot network.

23. The hotspot system of claim 19, wherein the SSID generated by the first computing device may be associated with a promotional activity or a third-party brand as part of the suffix of the SSID.

24. The hotspot system of claim 19, wherein the first computing device may also function as firmware on a router or modem device, thereby providing hotspot functionality alongside standard networking functions.

25. The hotspot system of claim 19, wherein the system uses local authentication databases for verifying the identity of guest devices and providing secure access to the network.

26. The hotspot system of claim 19, wherein the software includes a token-based transaction system for credit redemption, providing non-repudiable proof of access between the first and second computing devices.
